(19) United States
(12) Patent Application Publication
(10) Pub. No.: US 2026/0020015 A1
(43) Pub. Date: Jan. 15, 2026

(54) SCHEDULING REQUEST FOR RESOURCE ALLOCATION IN DOWNLINK DIRECTION

(71) Applicant: Apple Inc., Cupertino, CA (US)

(72) Inventors: Ping-Heng Kuo, London (GB); Fangli Xu, Beijing (CN)

(21) Appl. No.: 19/112,382

(22) PCT Filed: Sep. 23, 2022
(86) PCT No.: PCT/CN2022/120734

§ 371 Date: Mar. 17, 2025

(51) Int. Cl. H04W 72/1263; H04L 5/00; H04L 43/0811

(52) U.S. Cl. CPC H04W 72/1263; H04L 5/0044; H04L 43/0811

(57) ABSTRACT

A user equipment (UE) including a transceiver and a processor is disclosed. The processor is configured to receive, via the transceiver and from a base station, a plurality of scheduling request (SR) configurations including a first SR configuration and a second SR configuration. The first SR configuration may correspond with a resource allocation request for data communication in a first set of directions, and the second SR configuration may correspond with a resource allocation request for data communication in a second set of directions. The processor is configured to determine whether a condition to request a resource allocation has occurred. In response to the determination that the condition to request the resource allocation has occurred, the processor is configured to select a SR configuration of the plurality of SR configurations, and transmit, via the transceiver and to the base station, a SR using the selected SR configuration.

### TECHNICAL FIELD

This application relates generally to wireless communication systems, including methods and systems for scheduling request for resource allocation in a downlink (DL) direction.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates an example flow-chart of operations that may be performed by a user equipment (UE) according to embodiments described herein.

FIG. 3 illustrates another example flow-chart of operations that may be performed by a UE according to embodiments described herein.

FIG. 4 illustrates an example flow-chart of operations that may be performed by a base station according to embodiments described herein.

FIG. 5 illustrates an example architecture of a wireless communication system, according to embodiments described herein.

FIG. 6 illustrates a system for performing signaling between a wireless device and a network device, according to embodiments described herein.

### DETAILED DESCRIPTION

Various embodiments in the present disclosure are related to systems and methods of a scheduling request for a resource allocation, in particular, for a resource allocation in a downlink (DL) direction. In the Third Generation Partnership Project (3GPP) Technical Specification (TS) 38.321, a mechanism for scheduling request (SR) for a 5G new radio (NR) system is described. The mechanism for SR for the 5G NR system is described, in particular, for scheduling resource allocation in an uplink (UL) direction for a physical uplink shared channel (PUSCH) resource. In accordance with the mechanism for scheduling resource allocation in the UL direction, a user equipment (UE) may transmit a SR for obtaining a resource for PUSCH transmission. The PUSCH transmission may be triggered at the UE when the UE has data for transmission in the UL direction. A resource allocation in the UL direction may also be triggered at the UE when there is a beam failure detection (BFD) recovery, and/or a listen-before-talk (LBT) failure recovery. A UE may be configured or provisioned with at least one SR configuration. The at least one SR configuration may be mapped to a set of physical uplink control channel (PUCCH) resources for SR signaling (or transmission of a SR).

However, no mechanism is currently available for the UE to request a resource allocation in a downlink (DL) direction, or at least to suggest to a base station how soon a resource should be allocated for transmission to the UE in the DL direction. Some scenarios where a resource allocation for transmission to the UE in the DL direction are discussed below. Various embodiments in the present disclosure address this shortcoming, and describe how a SR can be made for a resource allocation for communication in a DL direction.

Reference will now be made in detail to representative embodiments/aspects illustrated in the accompanying drawings. The following description is not intended to limit the embodiments to one preferred embodiment. On the contrary, it is intended to cover alternatives, combinations, modifications, and equivalents as can be included within the spirit and scope of the described embodiments as defined by the appended claims.

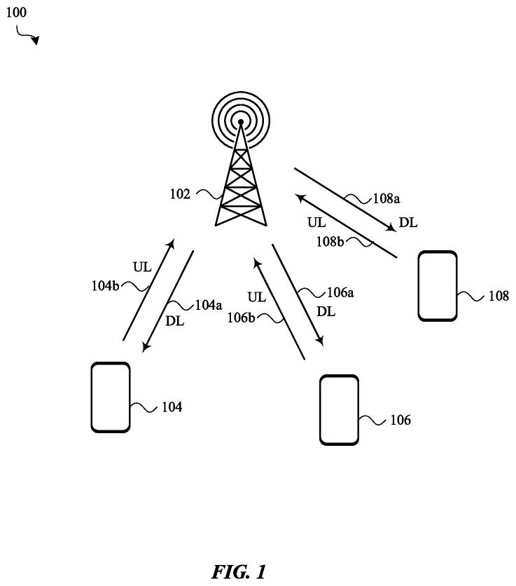

FIG. 1 shows an example wireless communication system, according to embodiments described herein. As shown in FIG. 1, a wireless communication system 100 may include a base station 102, a UE 104, a UE 106, and a server 108. In some embodiments, the base station 102 may be an eNb, an eNodeB, a gNodeB, or an access point (AP) in a RAN and may support one or more radio access technologies, such as 4G, 5G, 5G new radio (5G NR), and so on. The UE 104 or 106 may be a phone, a smart phone, a tablet, a smartwatch, an Internet-of-Things (IoT) device, a vehicle, a virtual reality (VR) equipment, an augment reality (AR) equipment, and/or an extended reality (XR) equipment, and so on. The server 108 may be an application server (or a VR server, a XR server, an AR server, or a spatial computing server (SCS)).

The UE 104 or the UE 106 may be a VR equipment, such as VR glasses. The UE 104 or the UE 106 may be executing various XR and/or media services (or applications), which are interactive. Such interactive XR and/or media services (or applications), therefore, have traffic in a UL direction and a DL direction mutually dependent. For example, pose or control information sent from the UE 104 or the UE 106 in a UL direction 104b or 106b may be received at the server 108 via the base stion 102 in a DL direction 108a. The server 108 may be located in a network. The network here may include a radio access network (RAN) and/or a core network.

The pose or control information received at the server 108 may then be processed by the server 108, and based on the processing, the server 108 may render media content to the UE 104 or the UE 106 over a UL direction 108b to the base station 102, and a DL direction 104a or 106a. For immersive experience to a user, the XR and/or media services with real-time interaction should have a very low roundtrip time or latency. In other words, time displacement between a UL transmission of the pose or control information and a DL transmission of media content as perceived by a user of the UE 104 or the UE 106 should be minimized. Accordingly, the UE 104 or the UE 106 may need to indicate to the base station 102 that a resource allocation in a DL direction is needed in response to a UL transmission of a PUSCH packet, such as pose or control information. The base station 102 may reduce the roundtrip time or latency by allocating a resource in a UL direction and a resource in a DL direction, when a SR for PUSCH resource allocation, for example, for pose or control information, is received.

In another scenario, a UE may need to send a SR for a resource allocation in DL direction, when the UE is executing an artificial intelligence (AI) model or a machine-learning (ML) model for purposes, including but not limited to, a channel state information (CSI) compression (or CSI feedback compression), positioning of the UE, and so on. Due to various reasons, such as a change or fluctuation in an environment, the AI model or the ML model needs to be updated from time to time. Even though a network may frequently provide an updated AI/ML model to the UE, that would be a waste of resources if the current AI/ML model executing on the UE is still satisfactory for the UE performance. Accordingly, the network and UE resources can be efficiently utilized when the network transmits an updated AI/ML model when the UE detects a need for the updated AI/ML model. The UE may detect that an updated AI/ML model is needed when there is a beam failure or consecutive negative acknowledgement (NACK) in the DL direction. Because of the beam failure or consecutive NACK, the UE may infer that the current AI/ML model for CSI compression is unable to provide accurate CSI to attain sufficient beamforming gain. The UE may, therefore, request the network to transmit a new or an updated AI/ML model to the UE in the DL direction. The UE may send a SR for a resource allocation in the DL direction via a specific SR configuration to request a new or an updated AI/ML model from the network.

Additionally, or alternatively, a UE may request a resource allocation in the DL direction in a 6G network where a UE may play a vital role of computing or sensing within the network. Various embodiments in the present disclosure describe extending a current SR framework to support a resource allocation for communication (or data communication) in the DL direction.

In some embodiments, SR configurations for a UE (or a MAC entity of a UE) may be divided into multiple groups. Each group may include at least one SR configuration, which corresponds to a resource allocation request in one or more directions (e.g., UL, DL, sidelink).

By way of a non-limiting example, SR configurations for a UE may be classified into three groups: Group A, Group B, and Group C. SR configurations in Group A may be used by the UE to request resource allocation in the UL direction. The SR configurations in Group A may be used by the UE to request a radio resource for uplink data transmission or activation of a specific configured grant (CG) configuration. SR configurations in Group B may be used by the UE to request resource allocation in UL and/or DL directions. SR configurations in Group B may also be used by the UE to request a radio resource for downlink data transmission or activation of a specific semi-persistent scheduling (SPS) configuration. SR configurations in Group C may be used by the UE to request resource allocation in a DL direction. Further, each SR configuration in Group C for requesting resource allocation in the DL direction may be used to request resource allocation in the DL direction for a specific purpose.

In some embodiments, SR configurations, and a particular SR configuration group to which each SR configuration is associated may be configured at the UE using a radio resource control (RRC) signaling. A new parameter, for example, sr-Group, may be added to a SchedulingRequestToAddMode information element (IE) of a SchedulingRequestConfig RRC message. The new parameter sr-Group may specify a SR configuration group number. Further, by way of a non-limiting example, a purpose of each SR configuration group may be fixed, or hardcoded. In some examples, a purpose of each SR configuration may be configurable, for example, using a new parameter, for example, sr-Purpose or sr-GroupPurpose. In some embodiments, a number of SR configuration groups may be predetermined, for example, four groups.

In some embodiments, instead of dividing or grouping SR configurations for a UE (or a MAC entity of a UE) into multiple groups, and each group including at least one SR configuration corresponding to a resource allocation request in one or more directions (e.g., UL, DL, sidelink) and/or for a specific purpose, one or more SR configurations for the UE (or the MAC entity of the UE) may be configured by a base station and/or a network for a specific purpose and/or for a resource allocation in one or more directions (e.g., UL, DL, sidelink). In some embodiments, each SR configuration in a SR configuration group may be associated with a respective call flow or a quality of service (QoS) flow.

Accordingly, in some embodiments, for example, a SR configuration #0 may be configured for requesting a resource allocation in a UL direction. By way of a non-limiting example, the resource allocation in the UL direction may be further defined or specified for data transmission over a particular logical channel (LCH) or a traffic flow, such as a LCH #1. The LCH #1 may be associated with a particular traffic flow. Similarly, a SR configuration #1 may be configured for requesting a resource allocation in a UL direction on a LCH #2 and activation of a particular CG configuration, and a SR configuration #2 may be configured for a beam failure recovery (BFR). Further, a SR configuration #3 may be configured for requesting resource allocation in a UL direction on a LCH #3 and requesting resource allocation in a DL direction, while a SR configuration #4 may be configured for requesting resource allocation in a UL direction on a LCH #4 and activation of a particular SPS configuration. In another example, a SR configuration #5 may be configured for requesting resource allocation in a DL direction for updating an AI model or an ML model for positioning, and a SR configuration #6 may be configured for requesting resource allocation in a DL direction for updating an AI model or an ML model for CSI compression.

As described herein, a purpose for each SR configuration may be specified or configured at the UE using a radio resource control (RRC) signaling. In some examples, a purpose of each SR configuration may be configured, for example, using a new parameter, for example, sr-Purpose. In some embodiments, a total number of SR configuration purposes may be predetermined, for example, eight different purposes.

In some embodiments, a purpose for requesting a resource allocation in a DL direction may correspond to or indicate a time period within which a resource for communication in a DL direction should be allocated by a base station. For example, one SR configuration may correspond to a request for resource allocation in a DL direction within 20 milliseconds (ms) after a SR is transmitted or signaled, while another SR configuration may correspond to a request for resource allocation in a DL direction within 100 milliseconds (ms) after a SR is transmitted or signaled. A purpose for requesting a resource allocation in a DL direction may correspond to or indicate a particular modulation and coding scheme (MCS).

In some embodiments, additionally, or alternatively, a new MAC CE may be used to indicate characteristics or a purpose for requesting a resource allocation in a DL direction. As described, the characteristics or the purpose for requesting a resource allocation in a DL direction may therefore include an AI model or an ML model update, an expected data communication or data transmission in a DL direction in response to a SR request for transmission in a UL direction or transmission of a particular data in a UL direction. The characteristics or the purpose for requesting a resource allocation in a DL direction may also include expected time of a DL resource allocation, a particular MCS, a repetition, target reliability of a DL resource allocation, and so on.

In some embodiments, a condition when a UE can transmit a SR for a resource allocation in a DL direction may be configured by a base station using RRC signaling. The condition when a UE can transmit a SR for a resource allocation in a DL direction may be specified in a SchedulingRequestConfig RRC signaling message. By way of a non-limiting example, a condition when a UE can transmit a SR for a resource allocation in a DL direction may include when a UE transmits a packet in a UL direction over a particular LCH and/or the packet corresponds to a particular media content and/or services. A condition when a UE can transmit a SR for a resource allocation in a DL direction may also include when a UE fails to decode consecutive physical downlink shared channel (PDSCH) for a predetermined number of times. The PDSCH may have its beam corresponding to a CSI compression based on a particular AI/ML model executing on the UE. Additionally, or alternatively, a UE may determine on its own when a SR for a resource allocation in a DL direction is to be sent.

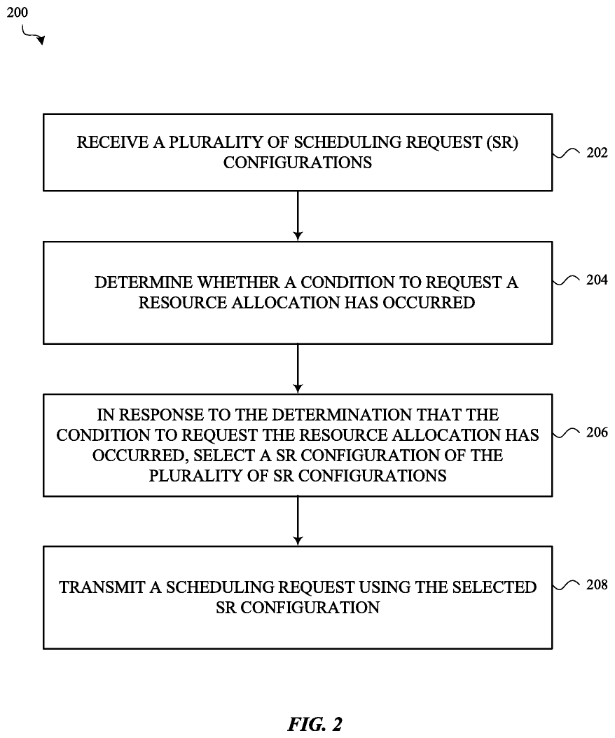

FIG. 2 illustrates an example flow-chart of operations that may be performed by a user equipment (UE) according to embodiments described herein. As shown in a flow-chart 200, at 202, a UE may receive, via a transceiver and from a base station, multiple SR configurations. As described herein, the multiple SR configurations may be received via a RRC signaling message. Each SR configuration of the multiple SR configurations may be associated with a particular SR configuration group, and/or each SR configuration of the multiple SR configurations may be associated with a resource allocation for a set of directions. The set of directions may include one or more directions (e.g., a UL direction, a DL direction, a sidelink direction, or any two of more of the UL direction, the DL direction, and the sidelink direction) and/or a particular purpose, as described herein.

In one example, a UE may receive at least a first SR configuration and a second SR configuration. The first SR configuration may be provisioned at the UE for a resource allocation request for data communication in a first set of directions (e.g., a UL direction), and the second SR configuration may be provisioned at the UE for a resource allocation request for data communication in a second set of directions (e.g., a DL direction). The first set of directions and the second set of directions, as described herein, are for example only, and a set of directions may include one or more directions (e.g., a UL direction, a DL direction, a sidelink direction, or any combination thereof). Further, the first SR configuration may correspond with a first SR configuration group, and the second SR configuration may correspond with a second SR configuration group.

At 204, the UE may determine whether a condition to request a resource allocation has occurred. For example, a condition to request a resource allocation in a UL direction may be when the UE has data to send in a UL direction. Similarly, a condition to request a resource allocation in a DL direction may be a failure to decode a PDSCH consecutively for a predetermined number of times. As described herein, the UE may be configured for one or more conditions corresponding to requesting a resource allocation in the DL direction.

In response to the determination that the condition to request the resource allocation has occurred, at 206, the UE may select a SR configuration of the plurality of SR configuration received at 202. The UE may select the SR configuration that corresponds with requesting a resource allocation in a direction and for the particular condition or purpose determined at 204.

At 208, the UE may transmit a SR using the selected SR configuration. If the SR request using a particular SR configuration is made to request a resource allocation in a DL direction, then upon receiving the SR request by a base station, the base station may allocate a resource for communication in a DL direction, and, thereby reducing a roundtrip time and latency.

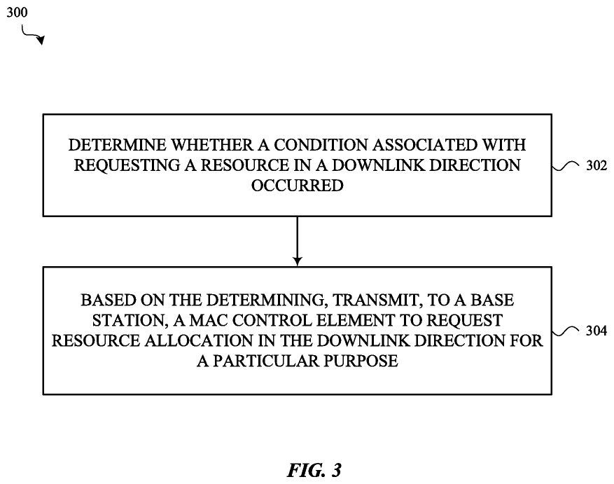

FIG. 3 illustrates another example flow-chart of operations that may be performed by a UE according to embodiments described herein. As shown in a flow-chart 300, at 302, the UE may determine whether a condition associated with requesting a resource allocation or a condition to request a resource allocation in a DL direction has occurred. As described herein, the UE may be configured for one or more conditions corresponding to requesting a resource allocation in the DL direction. Based on the determining whether the condition associated with requesting a resource allocation in a DL direction has occurred, at 304, the UE may transmit a MAC CE to a base station. The MAC CE may indicate a purpose or desired characteristics of a resource allocation in the DL direction.

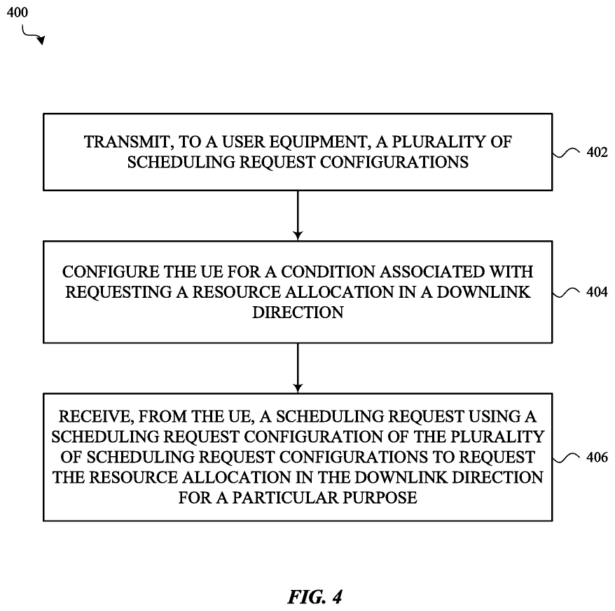

FIG. 4 illustrates an example flow-chart of operations that may be performed by a base station according to embodiments described herein. As shown in a flow-chart 400, at 402, a base station may transmit, via a transceiver, to a UE, multiple SR configurations. As described herein, the multiple SR configurations may be transmitted via an RRC signaling message. Each SR configuration of the multiple SR configurations may be associated with a particular SR configuration group, and/or each SR configuration of the multiple SR configurations may be associated with a resource allocation in one or more directions (e.g., UL, DL, sidelink) and/or a particular purpose, as described herein.

At 404, the base station may configure the UE with one or more conditions for which the UE can transmit a SR request for a resource allocation in a DL direction. Based on a determination made by the UE, based on the one or more conditions configured at 404, at 406, the base station may receive a SR using a SR configuration of the multiple SR configurations. The SR request using the particular SR configuration when received by a base station, the base station may allocate a resource for communication in a DL direction, and, thereby reducing a roundtrip time and latency.

Embodiments contemplated herein include one or more non-transitory computer-readable media storing instructions to cause an electronic device, upon execution of the instructions by one or more processors of the electronic device, to perform one or more elements of the method 200, 300, or 400. In the context of method 200 or 300, this non-transitory computer-readable media may be, for example, a memory of a UE (such as a memory 606 of a wireless device 602 that is a UE, as described herein). In the context of method 400, this non-transitory computer-readable media may be, for example, a memory of a base station (such as a memory 624 of a network device 620 that is a base station, as described herein).

Embodiments contemplated herein include an apparatus having logic, modules, or circuitry to perform one or more elements of the method 200, 300, or 400. In the context of method 200, or 300, this apparatus may be, for example, an apparatus of a UE (such as a wireless device 602 that is a UE, as described herein). In the context of method 400, this apparatus may be, for example, an apparatus of a base station (such as a network device 620 that is a base station, as described herein).

Embodiments contemplated herein include an apparatus having one or more processors and one or more computer-readable media, using or storing instructions that, when executed by the one or more processors, cause the one or more processors to perform one or more elements of the method 200, 300, or 400. In the context of method 200 or 300, this apparatus may be, for example, an apparatus of a UE (such as a wireless device 602 that is a UE, as described herein). In the context of the method 400, this apparatus may be, for example, an apparatus of a base station (such as a network device 420 that is a base station, as described herein).

Embodiments contemplated herein include a signal as described in or related to one or more elements of the method 200, 300, or 400.

Embodiments contemplated herein include a computer program or computer program product having instructions, wherein execution of the program by a processor causes the processor to carry out one or more elements of the method 200, 300, or 400. In the context of method 200, or 300, the processor may be a processor of a UE (such as a processor(s) 604 of a wireless device 602 that is a UE, as described herein), and the instructions may be, for example, located in the processor and/or on a memory of the UE (such as a memory 606 of a wireless device 602 that is a UE, as described herein). In the context of method 400, the processor may be a processor of a base station (such as a processor(s) 622 of a network device 620 that is a base station, as described herein), and the instructions may be, for example, located in the processor and/or on a memory of the base station (such as a memory 624 of a network device 620 that is a base station, as described herein).

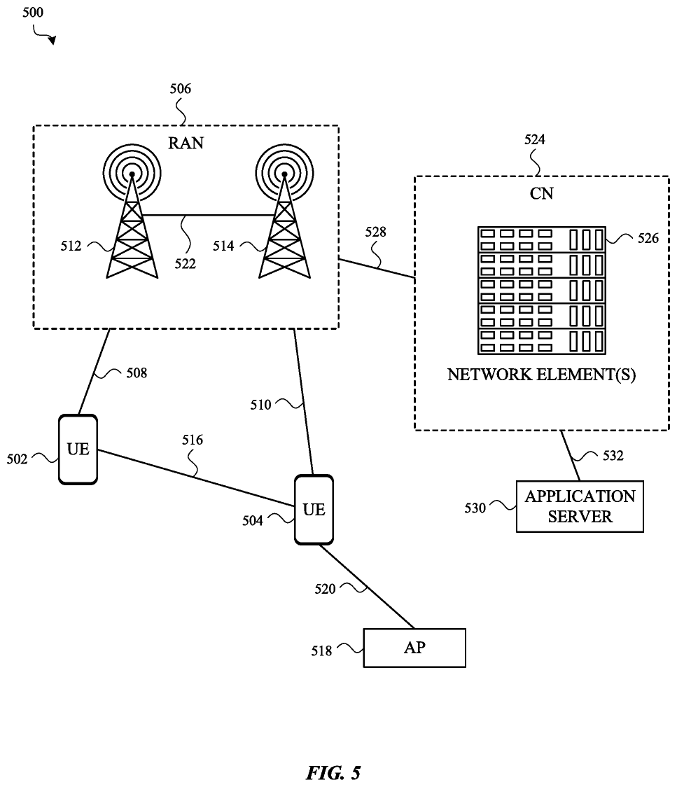

FIG. 5 illustrates an example architecture of a wireless communication system, according to embodiments described herein. The following description is provided for an example wireless communication system 500 that operates in conjunction with the LTE system standards and/or 5G or NR system standards as provided by 3GPP technical specifications.

As shown by FIG. 5, the wireless communication system 500 includes UE 502 and UE 504 (although any number of UEs may be used). In this example, the UE 502 and the UE 504 are illustrated as smartphones (e.g., handheld touchscreen mobile computing devices connectable to one or more cellular networks), but may also comprise any mobile or non-mobile computing device configured for wireless communication.

The UE 502 and UE 504 may be configured to communicatively couple with a RAN 506. In embodiments, the RAN 506 may be NG-RAN, E-UTRAN, etc. The UE 502 and UE 504 utilize connections (or channels) (shown as connection 508 and connection 510, respectively) with the RAN 506, each of which comprises a physical communications interface. The RAN 506 can include one or more base stations, such as base station 512 and base station 514, that enable the connection 508 and connection 510.

In this example, the connection 508 and connection 510 are air interfaces to enable such communicative coupling, and may be consistent with RAT(s) used by the RAN 506, such as, for example, an LTE and/or NR.

In some embodiments, the UE 502 and UE 504 may also directly exchange communication data via a sidelink interface 516. The UE 504 is shown to be configured to access an access point (shown as AP 518) via connection 520. By way of example, the connection 520 can comprise a local wireless connection, such as a connection consistent with any IEEE 802.11 protocol, wherein the AP 518 may comprise a Wi-Fi® router. In this example, the AP 518 may be connected to another network (for example, the Internet) without going through a CN 524.

In embodiments, the UE 502 and UE 504 can be configured to communicate using orthogonal frequency division multiplexing (OFDM) communication signals with each other or with the base station 512 and/or the base station 514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 512 or base station 514 may be implemented as one or more software entities running on server computers as part of a virtual network. In addition, or in other embodiments, the base station 512 or base station 514 may be configured to communicate with one another via interface 522. In embodiments where the wireless communication system 600 is an LTE system (e.g., when the CN 524 is an EPC), the interface 522 may be an X2 interface. The X2 interface may be defined between two or more base stations (e.g., two or more eNBs and the like) that connect to an EPC, and/or between two eNBs connecting to the EPC. In embodiments where the wireless communication system 600 is an NR system (e.g., when CN 524 is a 5GC), the interface 522 may be an Xn interface. The Xn interface is defined between two or more base stations (e.g., two or more gNBs and the like) that connect to the 5GC, between a base station 512 (e.g., a gNB) connecting to the 5GC and an eNB, and/or between two eNBs connecting to the 5GC (e.g., CN 524).

The RAN 506 is shown to be communicatively coupled to the CN 524. The CN 524 may comprise one or more network elements 526, which are configured to offer various data and telecommunications services to customers/subscribers (e.g., users of UE 502 and UE 504) who are connected to the CN 524 via the RAN 506. The components of the CN 524 may be implemented in one physical device or separate physical devices including components to read and execute instructions from a machine-readable or computer-readable medium (e.g., a non-transitory machine-readable storage medium).

In embodiments, the CN 524 may be an EPC, and the RAN 506 may be connected with the CN 524 via an S1 interface 528. In embodiments, the S1 interface 528 may be split into two parts, an S1 user plane (S1-U) interface, which carries traffic data between the base station 512 or base station 514 and a serving gateway (S-GW), and the S1-MME interface, which is a signaling interface between the base station 512 or base station 514 and mobility management entities (MMEs).

In embodiments, the CN 524 may be a 5GC, and the RAN 506 may be connected with the CN 524 via an NG interface 528. In embodiments, the NG interface 528 may be split into two parts, an NG user plane (NG-U) interface, which carries traffic data between the base station 512 or base station 514 and a user plane function (UPF), and the S1 control plane (NG-C) interface, which is a signaling interface between the base station 512 or base station 514 and access and mobility management functions (AMFs).

Generally, an application server 530 may be an element offering applications that use internet protocol (IP) bearer resources with the CN 524 (e.g., packet switched data services). The application server 530 can also be configured to support one or more communication services (e.g., VoIP sessions, group communication sessions, etc.) for the UE 502 and UE 504 via the CN 524. The application server 530 may communicate with the CN 524 through an IP communications interface 532.

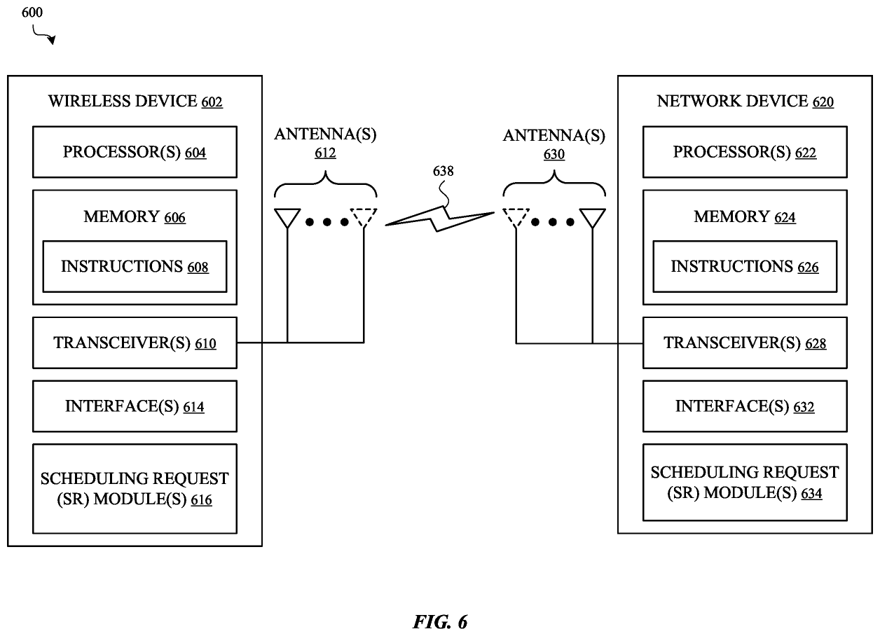

FIG. 6 illustrates a system 600 for performing signaling 638 between a wireless device 602 and a network device 620, according to embodiments described herein. The system 600 may be a portion of a wireless communication system as herein described. The wireless device 602 may be, for example, a UE of a wireless communication system. The network device 620 may be, for example, a base station (e.g., an eNB or a gNB) of a wireless communication system.

The wireless device 602 may include one or more processor(s) 604. The processor(s) 604 may execute instructions such that various operations of the wireless device 602 are performed, as described herein. The processor(s) 604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 602 may include a memory 606. The memory 606 may be a non-transitory computer-readable storage medium that stores instructions 608 (which may include, for example, the instructions being executed by the processor(s) 604). The instructions 608 may also be referred to as program code or a computer program. The memory 606 may also store data used by, and results computed by, the processor(s) 604.

The wireless device 602 may include one or more transceiver(s) 610 that may include radio frequency (RF) transmitter and/or receiver circuitry that use the antenna(s) 612 of the wireless device 602 to facilitate signaling (e.g., the signaling 638) to and/or from the wireless device 602 with other devices (e.g., the network device 620) according to corresponding RATs.

The wireless device 602 may include one or more antenna(s) 612 (e.g., one, two, four, or more). For embodiments with multiple antenna(s) 612, the wireless device 602 may leverage the spatial diversity of such multiple antenna(s) 612 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 602 may be accomplished according to precoding (or digital beamforming) that is applied at the wireless device 602 that multiplexes the data streams across the antenna(s) 612 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 602 may implement analog beamforming techniques, whereby phases of the signals sent by the antenna(s) 612 are relatively adjusted such that the (joint) transmission of the antenna(s) 612 can be directed (this is sometimes referred to as beam steering).

The wireless device 602 may include one or more interface(s) 614. The interface(s) 614 may be used to provide input to or output from the wireless device 602. For example, a wireless device 602 that is a UE may include interface(s) 614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 610/antenna(s) 612 already described) that allow for communication between the UE and other devices and may operate according to known protocols (e.g., Wi-Fi®, Bluetooth®, and the like).

The wireless device 602 may include a scheduling request (SR) module 616. The SR module 616 may be implemented via hardware, software, or combinations thereof. For example, the SR module 616 may be implemented as a processor, circuit, and/or instructions 608 stored in the memory 606 and executed by the processor(s) 604. In some examples, the SR module 616 may be integrated within the processor(s) 604 and/or the transceiver(s) 610. For example, the SR module 616 may be implemented by a combination of software components (e.g., executed by a DSP or a general processor) and hardware components (e.g., logic gates and circuitry) within the processor(s) 604 or the transceiver(s) 610.

The SR module 616 may be used for various aspects of the present disclosure, for example, aspects of FIGS. 1-4, from a remote UE perspective.

The network device 620 may include one or more processor(s) 622. The processor(s) 622 may execute instructions such that various operations of the network device 620 are performed, as described herein. The processor(s) 622 may include one or more baseband processors implemented using, for example, a CPU, a DSP, an ASIC, a controller, an FPGA device, another hardware device, a firmware device, or any combination thereof configured to perform the operations described herein.

The network device 620 may include a memory 624. The memory 624 may be a non-transitory computer-readable storage medium that stores instructions 626 (which may include, for example, the instructions being executed by the processor(s) 622). The instructions 626 may also be referred to as program code or a computer program. The memory 624 may also store data used by, and results computed by, the processor(s) 622.

The network device 620 may include one or more transceiver(s) 628 that may include RF transmitter and/or receiver circuitry that use the antenna(s) 630 of the network device 620 to facilitate signaling (e.g., the signaling 638) to and/or from the network device 620 with other devices (e.g., the wireless device 602) according to corresponding RATs.

The network device 620 may include one or more antenna(s) 630 (e.g., one, two, four, or more). In embodiments having multiple antenna(s) 630, the network device 620 may perform MIMO, digital beamforming, analog beamforming, beam steering, etc., as has been described.

The network device 620 may include one or more interface(s) 632. The interface(s) 632 may be used to provide input to or output from the network device 620. For example, a network device 620 that is a base station may include interface(s) 632 made up of transmitters, receivers, and other circuitry (e.g., other than the transceiver(s) 628/antenna(s) 630 already described) that enables the base station to communicate with other equipment in a network, and/or that enables the base station to communicate with external networks, computers, databases, and the like for purposes of operations, administration, and maintenance of the base station or other equipment operably connected thereto.

The network device 620 may include an SR module 634. The SR module 634 may be implemented via hardware, software, or combinations thereof. For example, the SR module 634 may be implemented as a processor, circuit, and/or instructions 626 stored in the memory 624 and executed by the processor(s) 622. In some examples, the SR module 634 may be integrated within the processor(s) 622 and/or the transceiver(s) 628. For example, the SR module 634 may be implemented by a combination of software components (e.g., executed by a DSP or a general processor) and hardware components (e.g., logic gates and circuitry) within the processor(s) 622 or the transceiver(s) 628.

The SR module 634 may be used for various aspects of the present disclosure, for example, aspects of FIGS. 1-4, from a base station perspective.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

We claim:

1. A user equipment (UE), comprising:
a transceiver; and
a processor configured to:
receive, via the transceiver and from a base station, a plurality of scheduling request (SR) configurations including a first SR configuration and a second SR configuration, the first SR configuration corresponds with a resource allocation request for data communication in a first set of directions, and the second SR configuration corresponds with a resource allocation request for data communication in a second set of directions;
determine whether a condition to request a resource allocation has occurred;
in response to the determination that the condition to request the resource allocation has occurred, select a SR configuration of the plurality of SR configurations; and
transmit, via the transceiver and to the base station, a SR using the selected SR configuration.

2. The UE of claim 1, wherein the plurality of SR configurations are segmented in a plurality of SR configuration groups, each SR configuration group of the plurality of SR configuration groups includes at least one SR configuration of the plurality of SR configurations, and each SR configuration group corresponds with a resource allocation request for data communication in a set of directions.

3. The UE of claim 2, wherein the set of directions includes:
an uplink (UL) direction;
a downlink (DL) direction;
a sidelink direction; or
a combination of any two or more of the UL direction, the DL direction, and the sidelink direction.

4. The UE of claim 2, wherein a respective SR configuration group for each SR configuration of the plurality of SR configurations is indicated to the UE via radio resource control (RRC) signaling.

5. The UE of claim 2, wherein each SR configuration in a SR configuration group of the plurality of SR configuration groups is associated with a respective traffic flow or a quality of service (QoS) flow.

6. The UE of claim 2, wherein:
a SR configuration corresponding to requesting allocation of resources for data communication in the DL direction, in a SR configuration group of the plurality of SR configuration groups, is associated with a particular duration from transmission of the SR request within which allocation of the resources is required.

7. The UE of claim 2, wherein:
the SR configuration is associated with allocation of resources in the DL direction with a particular modulation and coding scheme (MCS).

8. The UE of claim 1, wherein:
the first set of directions or the second set of directions includes:
an uplink (UL) direction;
a downlink (DL) direction;
a sidelink direction; or
a combination of any two of more of the UL direction, the DL direction, and the sidelink direction.

9. The UE of claim 8, wherein:
each SR configuration of the plurality of SR configurations is further associated with a respective purpose for data communication; and
the respective purpose is indicated to the UE via radio resource control (RRC) signaling.

10. The UE of claim 9, wherein the respective purpose of one SR configuration of the plurality of SR configurations is activation of a semi-persistent scheduling configuration.

11. The UE of claim 9, wherein the respective purpose of one SR configuration of the plurality of SR configurations is updating an artificial intelligence (AI) or a machine-learning (ML) model at the UE.

12. The UE of claim 11, wherein the AI or ML model at the UE is related to a virtual reality (VR) service, an augmented reality (AR) service, or an extended reality (XR) service.

13. The UE of claim 11, wherein the AI or ML model at the UE is related to positioning of the UE or channel state information (CSI) feedback compression.

14. The UE of claim 1, wherein the condition to request the resource allocation is received in a configuration from the base station.

15. The UE of claim 14, wherein the configuration specifying the condition to request the resource allocation is included in the SR configuration.

16. The UE of claim 1, wherein:
the condition to request the resource allocation comprises one or more of:
transmission of data in an uplink direction on a particular logical channel or associated with a particular traffic flow; or
failure to decode a physical downlink shared channel consecutively for a predetermined number of times.

17. A user equipment (UE), comprising:
a transceiver; and
a processor configured to:
determine whether a condition associated with requesting a resource for the data communication via the base station in a downlink (DL) direction has occurred; and
in response to the determining that the condition associated with requesting the resource for the data communication in the DL direction has occurred, transmit, via the transceiver and to the base station, a MAC control element (MAC CE) to request allocation of a resource in the downlink direction for a particular purpose.

18. The UE of claim 17, wherein:
the particular purpose comprises at least one of:
an update of an artificial intelligence (AI) model or a machine learning (ML) model at the UE;
a need of the allocation of the resource in the downlink direction within a particular time period;
a particular modulation and coding scheme; or
a particular target reliability.

19. A base station, comprising:
a transceiver; and
a processor configured to:
transmit, via the transceiver and to a user equipment (UE), a plurality of scheduling request (SR) configurations, each SR configuration of the plurality of SR configurations corresponds with requesting allocation of a resource for data communication via the base station in one or more directions;
configure the UE for a condition associated with requesting a resource for the data communication in a downlink (DL); and
receive, from the UE and via the transceiver, a scheduling request using a scheduling request configuration to request allocation of the resource in the downlink direction for a particular purpose.

20. The base station of claim 19, wherein:
the particular purpose comprises at least one of:
update of an artificial intelligence (AI) or a machine learning (ML) model at the UE;
need of the allocation of the resource in the downlink direction within a particular a particular modulation and coding scheme; or
a particular target reliability.
time period;
